(19) United States
(12) Patent Application Publication
(10) Pub. No.: US 2024/0236691 A1
(43) Pub. Date: Jul. 11, 2024

(54) Radio Access Network (RAN) System for Optimized Spectrum Sharing

(71) Applicant: Northeastern University, Boston, MA (US)

(72) Inventors: Leonardo BONATI, Boston, MA (US); Michele POLESE, Cambridge, MA (US); Salvatore D'ORO, Allston, MA (US); Tommaso MELODIA, Newton, MA (US)

(21) Appl. No.: 18/230,871

(22) Filed: Aug. 7, 2023

Related U.S. Application Data
(60) Provisional application No. 63/395,767, filed on Aug. 5, 2022.

(51) Int. Cl. H04W 16/14; H04W 24/02

(52) U.S. Cl. CPC H04W 16/14; H04W 24/02

(57) ABSTRACT

Provided herein are methods and systems for sharing spectrum, computing resources. and Radio Access Network (RAN) elements in a wireless communication network, the system including a centralized service management and orchestration (SMO) entity, the SMO including an optimization engine for determining one or more resource allocation policies responsive to one or more received tenant requests and based on network state information received from a radio access network (RAN) and deploying the determined resource allocation policies on the network, a plurality of edge datacenters configured to instantiate virtualized networking services in response to the deployed resource allocation policies from the optimization engine, and a plurality of cell sites, the cell sites operating the network in response to instructions from the edge datacenters consistent with the deployed resource allocation policies.

### CROSS REFERENCE TO RELATED APPLICATIONS

This application claims benefit under 35 U.S.C. § 119(e) of U.S. Provisional Application No. 63/395,767, filed on Aug. 5, 2022, entitled “Radio Access Network (RAN) System for Optimized Spectrum Sharing,” the entirety of which is incorporated by reference herein.

### STATEMENT REGARDING FEDERALLY SPONSORED RESEARCH OR DEVELOPMENT

This invention was made with government support under Grant Numbers 1925601 and 2112471 awarded by the National Science Foundation, and Grant Number N00014-20-1-2132 awarded by the Office of Naval Research. The government has certain rights in the invention.

### BACKGROUND

The need for higher data rates and reduced latency in cellular networks has resulted in unprecedented network densification, and in new deployment models where private operators deploy dedicated cellular infrastructure. As a consequence, access to spectrum, cell site facilities (e.g., poles, towers), Radio Access Network (RAN) and edge equipment represents the largest share of capital and operational expenses faced by public and private operators.

Higher costs and lower profits are barriers to technological innovation for the future of cellular networks. To lower these barriers, renting a neutral host infrastructure from a third-party company that leases physical resources (e.g., spectrum, towers, RAN) to multiple operators on a shared-tenant basis is seen as a promising solution, as it enables resource sharing and decreases the overall infrastructure costs. Spectrum sharing has also been widely investigated as a way to increase the overall spectral utilization. In fact, recent estimates indicate that joint adoption of neutral host models and spectrum sharing techniques can potentially lead to savings of at least 30% on network operational costs in the next five years.

RAN and spectrum sharing, however, are not ready for prime time in multi-operator network deployments, especially if one considers: (i) fine-grained sharing, with multiple tenants sharing computing and spectrum slices from the same physical infrastructure, and (ii) dynamic sharing, which allows infrastructure owners to fully exploit the statistical multiplexing of RAN and spectrum resources, and to tailor infrastructure parameters to tenant requirements that may change in a matter of seconds. For example, spectrum sharing in the CBRS band operates over time scales in the order of minutes, limiting the flexibility of the system and spectrum utilization efficiency.

Obstacles to further progress are both technological and strategic in nature and include the following.
1. Lack of automated and virtualized pipelines for multi-tenant management.

Zero-touch, resilient, fault-tolerant automation frameworks are currently unavailable in RAN environments. These are necessary for reliability and coordination among multiple tenants that dynamically share infrastructure and spectrum, without manual intervention and over-provisioning.
2. Lack of timely management of the life cycle of network services.

The dynamic allocation of spectrum and RAN infrastructure resources in a timely fashion is still a challenge, considering that complex software services, such as softwarized 5G Next Generation Node Bases (gNBs), need to be instantiated in a matter of seconds. This is because of the lack of low-latency end-to-end pipelines that interface with, keep track of, and coordinate available RAN elements and resources, and that manage the life cycle of network services.
3. Operators' perception of resource sharing as a risk.

Operators often perceive spectrum sharing as a risk and therefore prefer exclusive spectrum licensing. This is a consequence of the absence of reliable sharing solutions that can support Service Level Agreements (SLAs) through dynamic, fine-grained resource allocation provided through optimization engines.

### SUMMARY

Provided herein are radio access network (RAN) systems for optimized spectrum sharing. Such systems and methods represent a fundamental step toward enabling zero-touch dynamic and fine-grained RAN and spectrum sharing. Such radio access network (RAN) systems for optimized spectrum sharing (hereinafter “NeutRAN”) provide a neutral host framework that automatically manages the deployment of services on shared RAN and spectrum resources, based on high-level intents and requests from multiple tenants.

This is achieved by the provision of end-to-end pipelines that combine (i) a virtualized and automated RAN infrastructure with (ii) an optimization engine that defines optimal RAN and spectrum sharing policies. The NeutRAN framework, which was developed on top of the O-RAN architecture, extends virtualization and automation capabilities to a multi-tenant RAN, providing a fully managed and optimized solution for private and public neutral host-based deployments. This allows NeutRAN to break the traditional, isolated spectrum and infrastructure silos and to bring dynamic, fine-grained statistical multiplexing to the RAN and spectrum. That is. NeutRAN enables multiple tenants to access a shared RAN infrastructure.

In one aspect, a system for sharing spectrum, computing resources, and Radio Access Network (RAN) elements in a wireless communication network is provided. The system comprises a centralized service management and orchestration (SMO) entity. The SMO includes an optimization engine for determining one or more resource allocation policies responsive to one or more received tenant requests and based on network state information received from a radio access network (RAN) and deploying the determined resource allocation policies on the network. The system also includes a plurality of edge datacenters configured to instantiate virtualized networking services in response to the deployed resource allocation policies from the optimization engine. The system also includes a plurality of cell sites, the cell sites operating the network in response to instructions from the edge datacenters consistent with the deployed resource allocation policies.

In some embodiments, each received tenant request describes at least one of a service required, a resource needed, a fault-recovery policy, or combinations thereof. In some embodiments, the network state information includes at least one of infrastructure availability, spectrum availability, or both. In some embodiments, the resource allocation policies specify at least one of carrier frequency, bandwidth, cell site infrastructure, edge datacenter computing resources, or combinations thereof allocated to each tenant or tenant request. In some embodiments, the optimization engine is executable as an rAPP deployed in a non-real-time (non-RT) RAN intelligent controller (RIC) hosted in the SMO, In some embodiments, the edge datacenters instantiate the virtualized networking services in one or more near-real-time (near-30) RT) RAN intelligent controllers (RICs), non-RT RICs, 5G Next Generation Node Bases (gNBs), or combinations thereof. In some embodiments, the near-RT RIC includes at least one xApp configured to instruct each of the cell sites to operate the network consistent with the deployed resource allocation policies. In some embodiments, the near-RT RIC includes at least one xApp for monitoring the operation of the network.

In another aspect, a method of sharing spectrum, computing resources, and Radio Access Network (RAN) elements in a wireless communication network among a plurality of tenants is provided. The method includes receiving a plurality of tenant requests for network resources at a centralized service management and orchestration (SMO) entity. The method also includes determining, by an optimization engine of the SMO, one or more resource allocation policies responsive to the tenant requests, the policies based on the tenant requests and network state information received from a radio access network (RAN). The method also includes deploying the one or more resource allocation policies from the SMO to one or more edge datacenters. The method also includes instantiating virtualized networking services in response to the deployed resource allocation policies from the optimization engine. The method also includes dispatching instructions from the edge datacenters to the cell sites in order to carry out the resource allocation policies. The method also includes providing network services by the cell sites according to the resource allocation policies.

In some embodiments, the step of determining the one or more resource allocation policies further comprising specifying at least one of carrier frequency, bandwidth, cell sites, edge datacenter computing resources, or combinations thereof allocated to each tenant or tenant request. In some embodiments, the method also includes monitoring the provided network services by the edge datacenters and/or the SMO. In some embodiments, the method also includes recovering the provided network services responsive to detection of a failure or potential failure in the provision of the network services. In some embodiments, the method also includes executing the optimization engine as an rAPP deployed in a non-real-time (non-RT) RAN intelligent controller (RIC) hosted in the SMO.

In a further aspect, a system for preventing interference in a wireless communication network is provided. The system includes a plurality of cell sites of a radio access network (RAN). Each cell site includes a spectrum sensing application for monitoring spectrum activity in the network. Each cell site also includes an anomaly detection application for detecting an operation of the cell site in violation of one or more policy constraints and for stopping or correcting operation of the cell site responsive to the detected violation. The system also includes a near-real-time (near-RT) RAN intelligent controller (RIC). The near-RT RIC includes a spectrum map application for mapping a current state of spectrum activity associated with spectrum activity data received from the spectrum sensing applications of the cell sites. The near-RT RIC also includes a spectrum access application for instructing the cell sites to operate the network consistent with the policy constraints. The system also includes a centralized service management and orchestration (SMO) entity. The SMO includes a spectrum policy application for determining one or more of the policy constraints based on the mapping of the current state of the spectrum activity, the spectrum activity data, data external to the wireless communication network, or combinations thereof. The SMO also includes an orchestrator application for deploying the policy constraints to the spectrum access application.

In still another aspect, a method for preventing interference in a wireless communication network is provided. The method includes monitoring spectrum activity by a spectrum sensing application of each of a plurality of cell sites of a radio access network (RAN). The method also includes mapping, by a spectrum map application of a near-real-time (near-RT) RAN intelligent controller (RIC), a current state of spectrum activity associated with spectrum activity data received from the spectrum sensing applications of the cell sites. The method also includes determining, by a spectrum policy application of a centralized service management and orchestration (SMO) entity of the RAN, one or more policy constraints based on the mapping of the current state of the spectrum activity, the spectrum activity data, data external to the wireless communication network, or combinations thereof. The method also includes deploying, by an orchestrator application of the SMO, the one or more policy constraints to a spectrum access application of the near-RT RIC. The method also includes instructing, by the spectrum access application, each cell site to operate the network consistent with the policy constraints. The method also includes detecting, by an anomaly detection application of the cell site, an operation of the cell site in violation of one or more policy constraints. The method also includes stopping or correcting operation of the cell site responsive to the detected violation.

In some embodiments, each of the spectrum sensing applications is executable as a dAPP deployed in at least one of a distributed unit (DU) or a radio unit (RU) of the RAN. In some embodiments, the step of detecting also includes detecting transmission of a non-incumbent signal on a same spectrum as an incumbent signal. In some embodiments, the method also includes retrieving communications data from a data source external to the wireless communication network by the spectrum policy application, the data including at least one of FCC data, environmental sensing capability (ESC) data, spectrum access system (SAS) data, or multi-access edge computing (MEC) data. In some embodiments, the step of determining also includes at least partially basing the one or more policy constraints on the retrieved communications data. In some embodiments, the method also includes receiving, at a control interface application of the SMO commands from one or more of an operational command manager or a spectrum manager. In some embodiments, the step of determining also includes at least partially basing the one or more policy constraints on the received commands.

Additional features and aspects of the technology include the following:
1. A system for sharing spectrum, computing resources, and Radio Access Network (RAN) elements in a wireless communication network, the system comprising:
a centralized service management and orchestration (SMO) entity, the SMO including an optimization engine for determining one or more resource allocation policies responsive to one or more received tenant requests and based on network state information received from a radio access network (RAN) and deploying the determined resource allocation policies on the network:
a plurality of edge datacenters configured to instantiate virtualized networking services in response to the deployed resource allocation policies from the optimization engine; and
a plurality of cell sites, the cell sites operating the network in response to instructions from the edge datacenters consistent with the deployed resource allocation policies.
2. The system of feature 1, wherein each received tenant request describes at least one of a service required, a resource needed, a fault-recovery policy, or combinations thereof.
3. The system of any of features 1-2, wherein the network state information includes at least one of infrastructure availability, spectrum availability, or both.
4. The system of any of features 1-3, wherein the resource allocation policies specify at least one of carrier frequency, bandwidth, cell site infrastructure, edge datacenter computing resources, or combinations thereof allocated to each tenant or tenant request.
5. The system of any of features 1-4, wherein the optimization engine is executable as an rAPP deployed in a non-real-time (non-RT) RAN intelligent controller (RIC) hosted in the SMO.
6. The system of any of features 1-5, wherein the edge datacenters instantiate the virtualized networking services in one or more near-real-time (near-RT) RAN intelligent controllers (RICs), non-RT RICs, 5G Next Generation Node Bases (gNBs), or combinations thereof.
7. The system of feature 6, wherein the near-RT RIC includes at least one xApp configured to instruct each of the cell sites to operate the network consistent with the deployed resource allocation policies.
8. The system of features 6-7, wherein the near-RT RIC includes at least one xApp for monitoring the operation of the network.
9. A method of sharing spectrum, computing resources, and Radio Access Network (RAN) elements in a wireless communication network among a plurality of tenants, the method comprising:
receiving a plurality of tenant requests for network resources at a centralized service management and orchestration (SMO) entity;
determining, by an optimization engine of the SMO, one or more resource allocation policies responsive to the tenant requests, the policies based on the tenant requests and network state information received from a radio access network (RAN);
deploying the one or more resource allocation policies from the SMO to one or more edge datacenters
instantiating virtualized networking services in response to the deployed resource allocation policies from the optimization engine:
dispatching instructions from the edge datacenters to the cell sites in order to carry out the resource allocation policies; and
providing network services by the cell sites according to the resource allocation policies.
10. The method of feature 9, the step of determining the one or more resource allocation policies further comprising specifying at least one of carrier frequency, bandwidth, cell sites, edge datacenter computing resources, or combinations thereof allocated to each tenant or tenant request.
11. The method of any of features 9-10, further comprising monitoring the provided network services by the edge datacenters and/or the SMO.
12. The method of feature 11, further comprising recovering the provided network services responsive to detection of a failure or potential failure in the provision of the network services.
13. The system of any of features 9-12, further comprising executing the optimization engine as an rAPP deployed in a non-real-time (non-RT) RAN intelligent controller (RIC) hosted in the SMO.
14. A system for preventing interference in a wireless communication network comprising: a plurality of cell sites of a radio access network (RAN), each including:
   a spectrum sensing application for monitoring spectrum activity in the network:
and
   an anomaly detection application for detecting an operation of the cell site in violation of one or more policy constraints and for stopping or correcting operation of the cell site responsive to the detected violation;
a near-real-time (near-RT) RAN intelligent controller (RIC) including:
   a spectrum map application for mapping a current state of spectrum activity associated with spectrum activity data received from the spectrum sensing applications of the cell sites; and
   a spectrum access application for instructing the cell sites to operate the network consistent with the policy constraints; and a centralized service management and orchestration (SMO) entity including:
   a spectrum policy application for determining one or more of the policy constraints based on the mapping of the current state of the spectrum activity, the spectrum activity data, data external to the wireless communication network, or combinations thereof; and
   an orchestrator application for deploying the policy constraints to the spectrum access application.
15. A method for preventing interference in a wireless communication network comprising:
monitoring spectrum activity by a spectrum sensing application of each of a plurality of cell sites of a radio access network (RAN):
mapping, by a spectrum map application of a near-real-time (near-RT) RAN intelligent controller (RIC), a current state of spectrum activity associated with spectrum activity data received from the spectrum sensing applications of the cell sites:
determining, by a spectrum policy application of a centralized service management and orchestration (SMO) entity of the RAN, one or more policy constraints based on the mapping of the current state of the spectrum activity, the spectrum activity data, data external to the wireless communication network, or combinations thereof;
deploying, by an orchestrator application of the SMO, the one or more policy constraints to a spectrum access application of the near-RT RIC;
instructing, by the spectrum access application, each cell site to operate the network consistent with the policy constraints;
detecting, by an anomaly detection application of the cell site, an operation of the cell site in violation of one or more policy constraints; and stopping or correcting operation of the cell site responsive to the detected violation.
16. The method of feature 15, wherein each of the spectrum sensing applications is executable as a dAPP deployed in at least one of a distributed unit (DU) or a radio unit (RU) of the RAN.
17, The method of any of features 15-16, the step of detecting further comprising detecting transmission of a non-incumbent signal on a same spectrum as an incumbent signal.
18. The method of any of features 15-17, further comprising retrieving communications data from a data source external to the wireless communication network by the spectrum policy application, the data including at least one of FCC data, environmental sensing capability (ESC) data, spectrum access system (SAS) data, or multi-access edge computing (MEC) data.
19. The method of feature 18, wherein the step of determining further comprises at least partially basing the one or more policy constraints on the retrieved communications data.
20. The method of any of features 15-19, further comprising:
receiving, at a control interface application of the SMO commands from one or more of an operational command manager or a spectrum manager:
   wherein the step of determining further comprises at least partially basing the one or more policy constraints on the received commands.

### BRIEF DESCRIPTION OF THE DRAWINGS

FIG. 1 illustrates a NeutRAN framework alongside indications of a corresponding six step NeutRAN workflow, from request generation to service provisioning.

FIG. 2 illustrates a NeutRAN edge datacenter, with a pool of shared computing and spectrum resources. The NeutRAN pipelines define how these resources are sliced into Radio Access Network (RAN) services and spectrum allocations for the NeutRAN tenants.

FIG. 3 illustrates an OpenShift-based NeutRAN prototype.

FIG. 4A illustrates a computational complexity analysis showing computation time, in seconds, as a function of different numbers of spectrum bands (W) and grouping coefficients (K) by using both VR and PG, wherein number of requests (I)=20 and number of cell sites (B)=50.

FIG. 4B illustrates a computational complexity analysis showing number of variables (solid lines) and constraints (dashed lines) as a function of different numbers of spectrum bands (W) and grouping coefficients (K) by using both VR and PG, wherein I=20 and B=50.

FIGS. 5A-5C respectively illustrate acceptance, cell site activation, and band utilization ratios as a function of the number of requests (I) for different values of P_{NS} and number of cell sites (B), wherein W=5. The legend shown in FIG. 5A is applicable to FIGS. 5B and 5C.

FIGS. 6A-6C respectively illustrate acceptance, cell site activation, and band utilization ratios as a function of the number of requests (I) for different values of P_{SB} and number of cell sites (B), wherein W=5. The legend shown in FIG. 6A is applicable to FIGS. 6B and 6C.

FIG. 7 illustrates an experimental NeutRAN setup on an over-the-air Software Defined Radio (SDR testbed.

FIG. 8 illustrates Average, sum, and median throughput metrics. With No sharing, three tenants deploy their RAN on independent spectrum (10 MHz each, fora total of 30 MHz) and cell sites and equipment. With Sharing, 30 MHz, the tenants share the RAN infrastructure, cell sites, and 30 MHz of spectrum with the NeutRAN architecture. Finally, Sharing, 10 MHZ features the same sharing configuration, but only uses 10 MHz of spectrum. The 95% confidence intervals are shown.

FIGS. 9A-9C respectively illustrate CDF of UE throughput, downlink MCS, and uplink SINR. With No Sharing, three tenants deploy their RAN on independent spectrum (10 MHz each, for a total of 30 MHz) and cell sites and equipment. With 30 MHz Sharing, the tenants share the RAN infrastructure, cell sites, and 30 MHz of spectrum with the NeutRAN architecture. Finally, with 10 MHz Sharing, the tenants share in a similar manner to the 30 MHz sharing (e.g., sharing of the RAN infrastructure and cell sites), but only share 10 MHz of spectrum, rather than 30 MHz.

FIG. 10 illustrates time to instantiate pods vs. time to pull pod images for various NeutRAN components.

FIG. 11 illustrates a cellular network having integrated Spectrum Access System (SAS) functionality deployed and managed by a NeutRAN architecture.

FIG. 12 illustrates a framework of the NeutRAN architecture of the cellular network of FIG. 11. The framework includes cooperative components including dApps deployed at the Distributed Units (DUs), xApps deployed at a near-real-time RIC of the central units (CU), and rApps deployed at a non-real-time RIC of a service management and orchestration (SMO) framework.

FIG. 13 illustrates a distributed unit having a spectrum sensing component of the NeutRAN architecture deployed thereon.

### DETAILED DESCRIPTION

Provided herein are radio access network (RAN) systems for optimized spectrum sharing. Such systems and methods represent a fundamental step toward enabling zero-touch dynamic and fine-grained RAN and spectrum sharing. Such radio access network (RAN) systems for optimized spectrum sharing (hereinafter “NeutRAN”) provide a neutral host framework that automatically manages the deployment of services on shared RAN and spectrum resources, based on high-level intents and requests from multiple tenants.

### O-RAN Primer

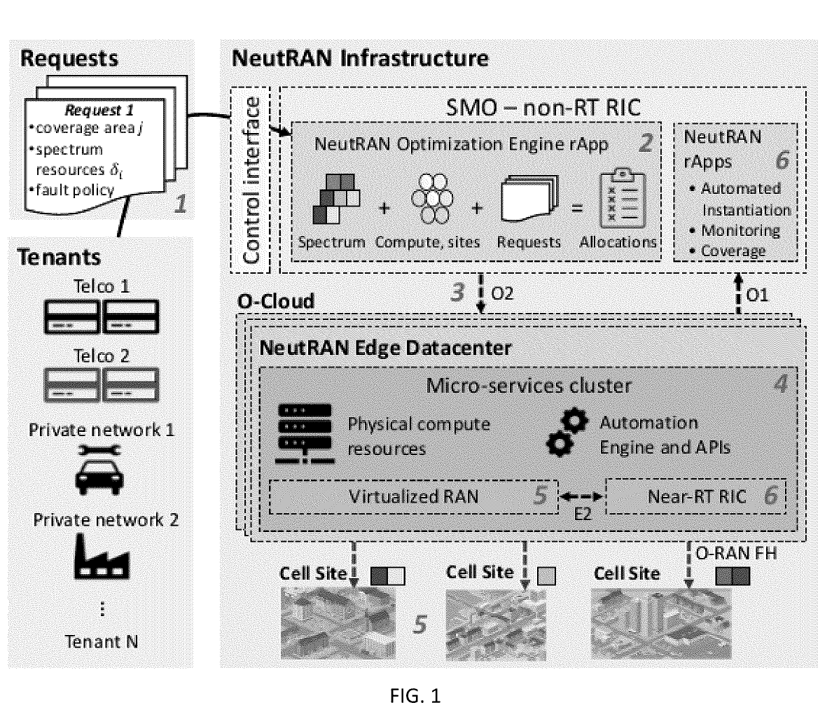

O-RAN is a disaggregated approach to deploy mobile cellular networks built upon cloud-native principles. It introduces standardized interfaces that facilitate interoperability among disaggregated network elements (e.g., Central Unit (CU), Distributed Unit (DU), Radio Unit (RU)), and RAN Intelligent Controllers (RICs) to oversee and fine-tune the functionalities of the network. RICs operate at different time scales to enable data-driven closed-control loops and network management through custom applications, called rApps (for the non-real-time RIC) and xApps (in the near-real-time RIC). These applications receive live Key Performance Measurements (KPMs) from the RAN and adapt its configuration to the dynamic channel conditions and traffic demand. O-RAN also enables the deployment of virtualized services for the RAN in a pool of computing resources (the O-Cloud) managed by the SMO (FIG. 1), a centralized component deployed in a cloud facility. The SMO provides an abstract view of the network infrastructure and resources (e.g., computing, spectrum, coverage) obtained by using the O-RAN O1 interface. It also triggers new service deployment and updates through the O-RAN O2 interface, which connects the SMO to virtualization resources in the O-Cloud. The SMO hosts the O-RAN non-real-time (non-RT) RIC and its rApps.

### The NeuTRAN Framework

The NeutRAN framework builds upon two components: (i) an optimization engine for guaranteed coverage and quality of service requirements that accounts for the limited amount of shared spectrum and RAN nodes, and (ii) a fully virtualized and automated infrastructure that converts the output of the optimization engine into deployable micro-services to be executed at RAN nodes and cell sites. That is, NeutRAN combines an O-RAN-based softwarized and automated infrastructure and an optimization engine for practical and efficient RAN and spectrum sharing. The NeutRAN stakeholders are tenants, who want to provide services to their end users, and a NeutRAN operator, who owns the infrastructure and provides access to the automated RAN and spectrum sharing pipelines.

In use, tenants access a high-level control interface to submit requests to deploy cellular connectivity in certain areas. Based on the available physical resources, these requests are then automatically converted into a set of virtualized networking services and functionalities deployed by NeutRAN on edge datacenters. A bird's-eye view of a NeutRAN framework is shown in FIG. 1, discussed in greater detail below.

NeutRAN components. NeutRAN consists of three main architectural components: (i) an SMO: (ii) edge datacenters, and (iii) cell sites. The SMO in the NeutRAN architecture includes an instance of non-RT RIC with an rApp implementing the optimization engine. Inputs to the engine include tenant requests and analytics from the RAN gathered by a monitoring rApp. Requests from the NeutRAN tenants are then matched into services to be deployed in the O-Cloud through the OpenShift Kubernetes Application Programming Interfaces (APIs). Other NeutRAN rApps automate service instantiation, and infrastructure monitoring for self-healing purposes. Last, a coverage rApp monitors historical and current coverage data to identify areas covered by each cell site (a key step in the optimization process, as described herein below).

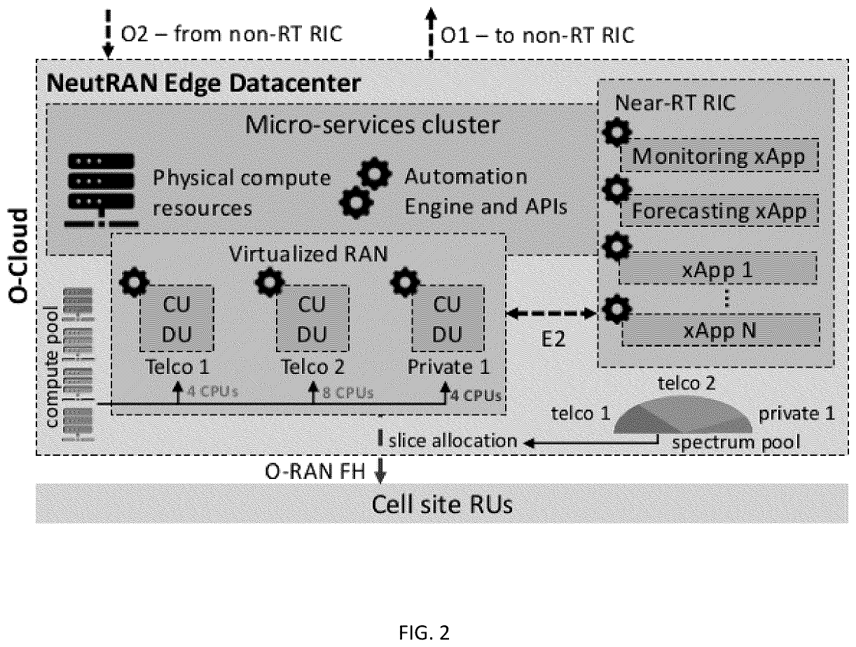

The NeutRAN edge datacenters are sketched in FIG. 2. As part of the O-Cloud resource pool, they are implemented through OpenShift, the open-source enterprise-ready hybrid cloud platform-as-a-service framework by Red Hat. OpenShift leverages containerized virtualization technologies managed by Kubernetes to instantiate applications and workloads in the form of containers (or pods) on top of white-box computing machines. This framework also offers primitives and APIs to instantiate and manage the life cycle of custom workloads on top of the managed infrastructure. Typical workloads include the virtualized core network and RAN, with the CUs and DUs for different tenants, the near-real-time (near-RT) RIC, connected to the virtualized RAN through the E2 interface, and the xApps running on the near-RT RIC. NeutRAN xApps aid and augment the operations of the optimization engine by providing additional monitoring and forecasting of user demand and resource utilization. The combination of custom OpenShift pipelines and of the directives from the optimization engine rApp enable efficient slicing of the edge datacenter resources, e.g., computing for NeutRAN services and spectrum to be used by the CUs and DUs (FIG. 2). As discussed below, automated pipelines in the NeutRAN edge datacenters can start customized network services and workloads in less than 10 s. The edge datacenters also expose Flask REST APIs to let the SMO monitoring rApp query the current resource availability (e.g., computing and spectrum) in the OpenShift clusters.

NeutRAN datacenters are connected to multiple cell sites in specific geographic areas via high-speed fiber connections, e.g., the O-RAN Fronthaul (FH) interface. Cell sites host RUs and antennas to provide RAN access over multiple frequency bands.

The NeutRAN Automated Workflow. The NeutRAN end-to-end automated workflow is structured in six steps, shown in FIG. 1. The first step 1 concerns tenant request submission to NeutRAN through intents that describe the services required by the tenant (e.g., to cover a specific geographic area in a certain period of time), needed resources (e.g., spectrum), and fault-recovery policies (e.g., whether to re-instantiate services in case of failure). These requests, together with spectrum and infrastructure availability, are the input to the rApp in the SMO that implements the optimization engine in the second step 2, whose outputs are allocation policies sent to the edge datacenters through the O2 interface in the third step 3. These policies specify the spectrum (carrier frequency and bandwidth) allocated to each tenant, together with the cell sites and computing resources in the edge datacenters. In the fourth step 4, the NeutRAN edge shown in FIG. 2 uses the automated pipelines of OpenShift to dispatch services such as the CUs/DUs, core network, and near-RT RICs required by the tenants, together with the xApps in the tenant's catalog. Upon instantiation, RAN services automatically connect to the core network and near-RT RIC running in the edge datacenter, report run-time KPMs to the RIC through the O-RAN E2 interface, and expose functionalities the xApps can subscribe to. Note that, based on the optimal allocation policy, multiple tenants can share the same base station. In this case, spectrum is shared by means of RAN slicing, where each tenant is assigned a different slice of the network (e.g., a subset of the available bandwidth). By the fifth step 5, the services required by the tenants on shared RAN and spectrum are fully provisioned. After the instantiation of these micro-services, in the sixth step 6 the edge datacenters and SMO run monitoring xApps and rApps to perform health checks on the deployed micro-services and resources, and to recover them from potential failures, thus effectively making the RAN self-healing.

The NeuTRAN Optimization Engine rApp

The NeutRAN optimization engine is implemented as an rApp (FIG. 1) that models the neutral host problem with data analytics from the SMO and RAN, defines the proper constraints, and solves the problem with custom reformulation-linearization techniques.

### A. System Model

The RAN infrastructure in FIG. 1 has a set R={1, 2, . . . , B} of B cell sites and NeutRAN edge datacenters. This infrastructure is offered to a set [symbol] of T tenants according to the neutral host business model: each cell site can be leased to a tenant for a set amount of time to offer network access to their users. The deployment area is partitioned into a set [symbol] =1, 2, . . . , A of A areas. Each cell site covers one or more areas. For each area j ∈ [symbol] and cell site b ∈ [symbol] , the indicator variable [symbol] _{b,j} ∈ {0,1} is [symbol] _{b,j}=1 if b provides coverage to j, and [symbol] _{b,j}=0 otherwise. No assumptions are made with regard to how indicator variables [symbol] _{b,j} are computed, as different deployments may determine coverage with different policies. A realistic approach could set [symbol] _{b,j}=1 if and only if a metric γ_{b,j} (e.g., SINR or throughput) at cell site b for any user in area j exceeds a minimum tolerable value γ^{min}, where both γ_{b,j} and γₘᵢₙ can be obtained via historical data from the monitoring and coverage rApps. Let [symbol] _{b} ⊆ [symbol] be the set of areas covered by b ∈ [symbol] .

NeutRAN uses a set [symbol] of W 5G frequency bands. Let [symbol] _{ω}, be the set of frequencies in band [symbol] ∈ [symbol] . 5G systems rely upon an Orthogonal Frequency Division Multiplexing (OFDM) frame structure, which partitions frequencies into subcarriers. These are then organized into blocks of 12 to form the so-called Physical Resource Blocks (PRBs), which are the minimum units that can be scheduled in frequency. As a consequence, the set [symbol] _{ω}, which is the set of PRBs in band ω, is discretized. Therefore, ∪_{ω=1}^{W} [symbol] _{ω}= [symbol] .

Each cell site can operate across multiple bands. Thus, variable β_{b,f} ∈ {0,1} is introduced such that, for any band ω and cell site b, β_{b,f}=1, for all f ∈ [symbol] _{ω}, if b can operate on band ω. The indicator ξ_{b} ∈ {0,1} is also introduced such that ξ_{b}=1 if cell site b can transmit on a single band (among the bands supported by the cell site) at any given time.

Consider the case where each tenant in [symbol] can submit requests to provide wireless services at different locations. Specifically, each tenant t in [symbol] generates a set [symbol] ₜ of requests that are then collected into a set [symbol] =∪ₜ₌ [symbol] [symbol] ₜ with a total of I requests. As shown in FIG. 1, each request i ∈ [symbol] specifies the area j ∈ [symbol] where the service is needed, the required amount of resources &j, and the level of fault resiliency. Without loss of generality, consider a one-to-one mapping between a request i and its associated area j. (δᵢ represents the amount of PRBs required to accommodate the request. Its value might depend on a variety of factors such as number of users, their type (e.g., best-effort, premium), the type of traffic they generate (e.g., video streaming, browsing) as well as any SLAs in place between tenants and their customers, usually kept undisclosed out of privacy concerns. As such, no assumptions are made regarding how tenants compute the value of δᵢ, and design NeutRAN to let the tenants keep the models used to compute di undisclosed, having only to specify its value.

As cell sites offer limited coverage, define two sets [symbol] ᵢ and [symbol] ₋ᵢ to represent the cell sites that offer coverage to the area j specified by request i and those that do not, respectively. These sets are defined as [symbol] ᵢ={b ∈ [symbol] : r_{i,b}=1}⊆ [symbol] and [symbol] ₋ᵢ= [symbol] / [symbol] ᵢ, where r_{i,b} ∈ {0,1} is a variable used to determine whether or not cell site b is a suitable candidate to accommodate request i. Specifically, for any request i and its required area j, r_{i,b}=1 if and only if j ∈ [symbol] _{b}.

Finally, the parameter wᵢ models the value of request i. This adds flexibility to NeutRAN, as it can be used by tenants to declare the monetary value of their request, and by NeutRAN to prioritize profits over infrastructure utilization.

### B. Problem Definition

NeutRAN is designed to enable neutral host applications for Open RAN cellular systems offering at the same time an automated and optimized platform to (i) instantiate disaggregated 5G gNBs: (ii) allocate spectrum on-demand: (iii) avoid interference; and (iv) satisfy tenant requests.

Let y=( [symbol] _{i,b})_{i∈} [symbol] _{,b∈} [symbol] _{′}, and x=(X_{i,b,f})_{i∈} [symbol] _{, b∈} [symbol] _{,f ∈} [symbol] be the optimization variables. In this formulation, variable [symbol] _{i,b} ∈ {0, 1} is set to 1 if request i is assigned to cell site b; [symbol] _{i,b} otherwise. Variable x_{i,b,f} ∈ {0, 1} indicates which PRBs on cell site b have been allocated to request i, namely, x_{i,b,f}=1 indicates that PRB f in cell site b is assigned to request i. The constraints and objective of the optimization are as follows.
1) Avoid conflicts and spectrum over-provisioning: First, each request i can be allocated to one cell site b only to ensure that the infrastructure owner does not incur additional costs by instantiating many cell sites to satisfy the same request. For all i ∈ [symbol] , this is formulated as follows:

$${\sum }_{b ∈ R} {y}_{i , b} \leq 1 \qquad ( 1 )$$

Furthermore, it must be ensured that NeutRAN (i) does not allocate more PRBs than available; (ii) avoids conflicts by not allocating the same PRB to multiple requests (e.g., from different tenants); and (iii) mitigates interference by making sure neighboring cells do not operate over the same spectrum.

For each b and b′ ∈ [symbol] , let the interference indicator I_{b, b′} ∈ {0, 1} be such that I_{b,b′}=1 if b and b′ have overlapping coverage regions and interfere with each other if using the same spectrum. For all f ∈ [symbol] , and b, b′ ∈ [symbol] with I_{b,b′}=1, the following two inequalities model constraints (i)+(ii), and constraint (iii), respectively.

$${\sum }_{i ∈ J} {x}_{i , b , f} \leq {β}_{b , f} \qquad ( 2 )$$

$$\begin{matrix}{\sum }_{i ∈ J} ( {x}_{i , b , f} {β}_{i , b} + {x}_{i , {b}^{′} , f} {β}_{{b}^{′} , f} ) \leq 1 & ( 3 )\end{matrix}$$

Note that the left-hand side of Eq. (2) ensures that only supported bands can be allocated, and that the total number of PRBs allocated to each cell site does not exceed the total number of available PRBs. This is because F_{b}=Σ_{f ∈} [symbol] β_{b,f} indicates the number of PRBs available at b across all supported bands. Therefore, since β_{b,f}≤1, Eq. (2) enforces the allocation of no more than the available F_{b} PRBs.
2) Satisfy locality and spectrum demand: To satisfy request 1, NeutRAN can select any cell site b that covers area j requested by i, then r_{i,b}=1, and must satisfy the spectrum demand δᵢ by allocating enough PRBs to the request. These constraints can be defined jointly via Eq. (4) for all i ∈ [symbol] and b ∈ [symbol] .

$${\sum }_{f ∈ F} {x}_{i , b , f} {β}_{b , f} {r}_{i , b} = {δ}_{i} {y}_{i , b} \qquad ( 4 )$$

For all i ∈ [symbol] and b ∈ [symbol] , the following set of constraints, Eq. (5), forces to zero all variables that would result in an unfeasible solution where a request i is allocated to a cell site b that does not offer coverage to the required area. i.e., b ∈ [symbol] ₋ᵢ.

$${\sum }_{{b}^{′} ∈ {R}_{- i}} {y}_{i , {b}^{′}} + {\sum }_{{b}^{′} ∈ {R}_{- i}} {\sum }_{f ∈ F} {x}_{i , {b}^{′} , f} = 0 \qquad ( 5 )$$

3) Enforce contiguous allocation: Allocating contiguous PRBs to requests makes it possible to implement the sharing mechanism through RAN slicing and decreases the complexity of transceiver architectures. e.g., it eliminates the need for carrier aggregation. For all i ∈ [symbol] and b ∈ [symbol] , the contiguous allocation of PRBs can be enforced via the following constraint:

$${\sum }_{f = 1}^{F - 1} {x}_{i , b , f} \cdot {x}_{i , b , f + 1} {a}_{f , f + 1} = ( {δ}_{i} - 1 ) {y}_{i , b} \qquad ( 6 )$$

where α_{f,f′} ∈ {0,1} is such that α_{f,f}=0 and α_{f,f}′=1 if f and f′ belong to the same spectrum band w, then (f, f′) ∈ [symbol] _{w}× [symbol] _{w} and they are consecutive, i.e., f′=f±1. In this way, together with Eq. (4), Eq. (6) ensures that [symbol] _{i,b}=1 if and only if exactly δᵢ contiguous PRBs are allocated.
4) Support single band cell sites: Smaller cell sites (e.g., micro or pico cells) may support multiple spectrum bands but can transmit over a single spectrum band only at any given time. This must be enforced through Eq. (7) which, for all b ∈ [symbol] and ω∈ [symbol] such that ξ_{b}=1 (i.e., those b that only support single band operations), ensures that only one band is allocated to requests at any given time.

$${\sum }_{f ∈ {F}_{w}} {\sum }_{i ∈ J} {x}_{i , b , f} \cdot {\sum }_{{f}^{′} ∈ F ∖ {F}_{w}} {\sum }_{i ∈ J} {x}_{i , b , {f}^{′}} = 0 \qquad ( 7 )$$

### C. Problem Formulation

The neutral host optimization problem is as follows:

$${maximize}_{x , y} {\sum }_{i ∈ J} {\sum }_{b ∈ R} {y}_{i , b} {ω}_{i} \qquad ( 8 )$$

subject to Constraints (1), (2), (3), (4), (5), (6), (7)

x_{i,b,f}∈{0,1},∀i ∈ [symbol] ,b ∈ [symbol] ,f ∈

[symbol]

[symbol]

_{i,b}∈{0,1},∀i ∈ [symbol] ,b ∈

[symbol]

The objective of Eq. (8) is to accommodate as many requests as possible such that their cumulative value is maximized while satisfying the set of constraints discussed above. This formulation would also allow infrastructure owners to maximize the number of admitted requests rather than their cumulative value, if ωᵢ=1 for all i ∈ [symbol] .

### D. Complexity Analysis and Mitigation

The neutral host problem formalized above is a binary Quadratically Constrained Quadratic Program (QCQP), as the optimization variables x and y are 0-1 variables and constraints Eq. (6) and Eq. (7) are quadratic. As such, the problem is well-known to be NP-Hard. Despite the exponential complexity of such problems, Semidefinite Programming Relaxations (SPR) and Reformulation-Linearization Techniques (RLT) have been shown to be effective tools for solving them optimally.

The primary source of complexity of Eq. (8) stems from the number of variables N of the problem. i.e., N=Nₓ+N_{y}=IBF+IB ∈ [symbol] (IBF). Note that, while the number of requests I and the number B of cell sites might be arbitrarily large, the total number F of PRBs is upper-bounded by F^{MAX}=275 W, if all the [symbol] spectrum bands in W support the maximum number of PRBs allowed by 5G NR. For instance, in a scenario with B=5 cell sites, W=10 bands, each with 275 PRBs, and I=requests, there are more than 130,000 optimization variables and more than 600,000 constraints from Eq. (3) alone.

Therefore, the following complexity reduction and relaxation techniques can be used:

Variable Reduction (VR): any variable can be eliminated that: (i) always results in unfeasible solutions, or (ii) is always equal to zero due to the structure of the problem. For example, for any request i, allocating i to any cell site b ∈ [symbol] ₋ᵢ is unfeasible. Similarly, if cell site b ∈ [symbol] ᵢ, but a specific band ω ∈ [symbol] is not supported by the cell site, then any x_{i,b,f} with f ∈ [symbol] _{ω}, will always be equal to zero due to Eq. (2).

PRB grouping (PG): PRBs can be bundled together into groups of minimum size K such that the problem is cast into a space with \tilde{F}=F/K PRBs. A preliminary grouping is naturally occurring in any 5G NR systems as PRBs are grouped into Resource Block Groups (RBGs) with varying numbers of PRBs, depending on the specific numerology. This concept can be extended by allowing tenants to submit requests with a demand whose value is a multiple of a fixed block size K, i.e., δᵢ= [symbol] ᵢK, with [symbol] ᵢ an integer for all i ∈ [symbol] .

### A Neutran Prototype

NeutRAN was prototyped on an OpenShift cluster and on a programmable testbed with 4 base stations and 10 users from 3 different tenants. The prototype NeutRAN was compared to a traditional license-based RAN where each tenant has dedicated physical and spectrum resources. Experimental results show that NeutRAN increases the cumulative network throughput by 2.18× and the per-user average throughput by 1.73× with shared spectrum blocks of 30 MHz. NeutRAN also provides a 1.77× cumulative throughput gain even when it can only operate on a shared spectrum block of 10 MHz (one third of the spectrum used in the license-based case).

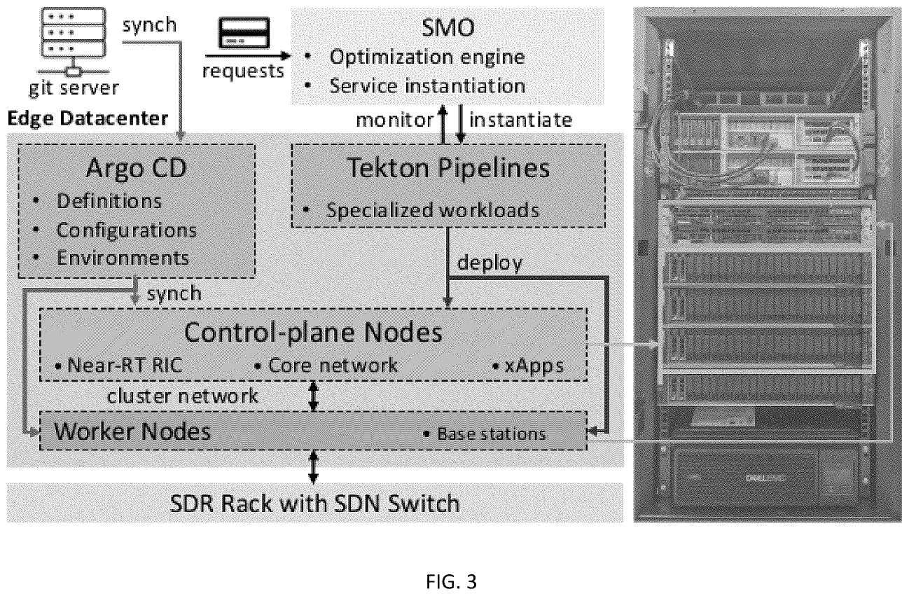

The NeutRAN prototype shown in FIG. 3 implements the framework described above. It features unique software and hardware components that enable automated pipelines for end-to-end, optimization-driven spectrum and RAN sharing.

Software automation. The overall software infrastructure involves more than 330 components executing as either micro-services deployed as OpenShift pods (e.g., containerized applications) or rApps in the SMO. To develop a NeutRAN prototype and enable the seamless transition from tenant requests (specified via a graphical control interface) to deployment of fully operational cellular networks, a set of custom automation pipelines have been implemented on top of the edge datacenter OpenShift infrastructure using open-source, cloud-native continuous integration and delivery frameworks. These make it possible to apply the output of the optimization engine rApp (in the SMO) to generic application templates (see e.g., Listing 1) and translate them into custom services that are then automatically deployed on the cluster. For illustrative purposes, Listing 1 below provides an example of a generic application template for deployment at a base station. The installed generic application template is configured to then be specialized at run time according to the output of the optimization engine rApp.

LISTING 1

| 1 | apiVersion: template.openshift.io/v1 | | |
|---|---|---|---|
| 2 | kind: Template | | |
| 3 | metadata: # template name (e.g., neutran) and annotations | | |
| 4 | parameters: # template parameters (e.g., frequencies; | | |
| | | core network, RIC, and USRP IP; slice allocations) | |
| 5 | objects: | | |
| 6 | - | kind: Deployment | |
| 7 | | apiVersion: apps/v1 | |
| 8 | | metadata: # deployment name (e.g., neutran-call-1), | |
| | | namespace (e.g., neutran), and labels | |
| 9 | | spec: | |
| 10 | | template: | |
| 11 | | metadata: # template labels, and annotations | |
| 12 | | spec: | |
| 13 | | nodeSelector: # to select low-latency nodes | |
| 14 | | containers: | |
| 15 | | - | name: # pod name (e.g., neutran-cell-1) |
| 16 | | | image: # Docker image (e.g., neutran-cell) |
| 17 | | | command: # pod-entrypoint (e.g., /run.sh) |
| 18 | | | env: # parameters of line 4 passed as |
| | | environment variables | |
| 19 | | | ports: # exposed ports and protocols |
| 20 | | | resources: # pod compute resources |

| | | |
|---|---|---|
| 21 | - | kind: Service # exposed services (e.g., Flask APIs) |
| 22 | - | kind: Route # routes to reach the exposed services |

Notably, the SMO uses an O2-like interface to control the OpenShift APIs and the various services deployed on the edge datacenter. The optimization engine rApp computes the optimal allocation of RAN services by solving the neutral host problem described herein, and automatically instantiates the resulting services (e.g., the RAN applications) by adapting a set of generic templates to the specific requested services at run time. Templates are deployed on the OpenShift cluster through the Argo Continuous Delivery (CD) framework, which supports declarative application definitions, configurations, and environments synchronized from a version-controlled source (e.g., a git server). Starting from these templates, the actual workloads and services resulting from the NeutRAN optimization are instantiated as pods from an internal Docker image registry through Tekton pipelines.

After their instantiation, applications and services are actively monitored by NeutRAN, which can tune their configuration at run time based on subsequent optimization results, and re-instantiate them if necessary (e.g., in case of conflicts between services, or failure of a certain service). In this way, NeutRAN is resilient to failures, and self-adapts to heterogeneous network deployments and diverse operator requests.

Software edge services. The functionalities that support OpenShift were deployed on dedicated control-plane nodes (e.g., cluster monitoring services, operators, certificate managers, DNS, etc.), which also host additional edge micro-services. These include (i) an E-release O-RAN near-RT RIC provided by the O-RAN Software Community (OSC), with an E2 termination to the RAN for data collection and performance reporting: (ii) data-driven xApps running on the near-RT RIC; and (iii) a core network implemented through Open5GS. Additional computing resources (worker nodes) were configured to only execute low-latency applications, e.g., the base stations, thus providing performance guarantees. The RAN is implemented through the SCOPE software-defined cellular stack, part of the publicly available Open RAN Gym framework. SCOPE extends srsRAN with network slicing capabilities (leveraged to implement spectrum sharing among the different tenants), and the O-RAN-compliant E2 termination to communicate with the near-RT RIC. Every application is containerized and exposes Flask REST APIs for monitoring and re-configuration.

Hardware. The three main infrastructure components of NeutRAN were configured as follows: (i) the SMO, on an Intel NUC (15 CPU cores, 64 GB RAM): (ii) the edge datacenter, on a bare-metal cluster managed by OpenShift; and (iii) four cell sites, on USRPs X310 part of an infrastructure with SDRs, antenna locations, and computational facilities. The cluster features three control-plane nodes (Dell PowerEdge R740, 32 CPU cores and 192 GB RAM) and two worker nodes (Microway EPYC, 32 CPU cores and 256 GB RAM). To ensure low latency and high performance, each node embeds a 100 Gbps Ethernet card from NVIDIA Mellanox. Workers connect to the SDRs via a Dell 4048T-ON Software-defined Networking (SDN) switch.

### Neutran Performance Evaluation

### A. NeutRAN Scalability, Complexity, and Effectiveness

Large-scale simulations were run to (i) evaluate the computational complexity and scalability of NeutRAN, and (ii) assess and characterize its performance to determine its applicability to real-world large-scale deployments.

The following results were generated through a custom MAT-LAB simulator that uses Gurobi to solve Eq. (8) on a computing node with 32 GB of RAM and a 12-core Intel Core i7-9750H CPU at 2.60 GHz. A deployment with 5G NR cell sites uniformly deployed on a grid with A=21×11=231 areas was considered. The RAN uses numerology 4, e.g., 240 KHz subcarrier spacing and 138 PRBs per band. The coverage indicators c_{b,j} were configured such that c_{b,j}=1 if area j ∈ [symbol] is distant at most 3 \sqrt{2}/2 from the cell site, where the distance is normalized with respect to the width of the area. A case where ωᵢ=1 (e.g., Eq. (8) aims at maximizing the number of admitted requests). All results are averaged over 100 independent simulation runs.

Complexity Analysis. The reduction techniques VR and PG presented above were leveraged and profiled for complexity reduction. Such techniques were analyzed to determine an optimal solution for Eq. (8) having a reduced complexity, avoiding lengthy computations of 60 s or more, even in scenarios with few cells or bands.

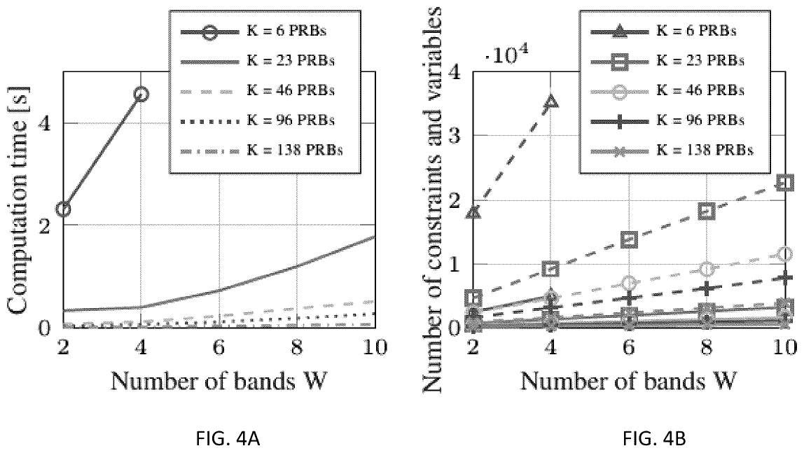

FIGS. 4A and 4B illustrate an analysis of the computational complexity of Eq. (8) aimed at showing the scalability of NeutRAN. Scenarios with variable numbers W of spectrum bands per cell site and different values of K were considered. FIG. 4A shows that NeutRAN can compute optimal solutions in few hundreds of milliseconds even in the case of large W and grouping coefficients K≥23 (which corresponds to dividing the available 138 PRBs in 6 groups of size 23). Grouping with higher values of K is indeed effective as it enables a 97% reduction in the computation times of optimal solutions (e.g., from 4.56 s of K=6 to 0.12 s of K=23 for W=4). This is due to the reduction in the number of variables (solid lines) and constraints (dashed lines) required to solve Eq. (8), which are shown in FIG. 4B.

NeutRAN Resource Utilization and Allocation Effectiveness. Another important aspect to investigate is how many requests are admitted by NeutRAN, as well as how many cell sites and spectrum bands are activated for different configurations and deployments. To capture real-world deployment characteristics, the probability P_{NS} models those cases where a cell site b can support a number of bands W_{b}≤W. In each run and for each b ∈ [symbol] and band W ∈ Ω, a random variable z is generated from a uniform distribution in [0, 1] and β_{b,f} is set as β_{b,f}=0 for each f ∈ ω if z<P_{NS}. Additionally, the value of the single band indicator variable ξ_{b} is modeled with a probability P_{SB}: for each b ∈ [symbol] the variable z is randomly drawn again and set ξb=1 if z<P_{SB}. In the following, W=5 is considered.

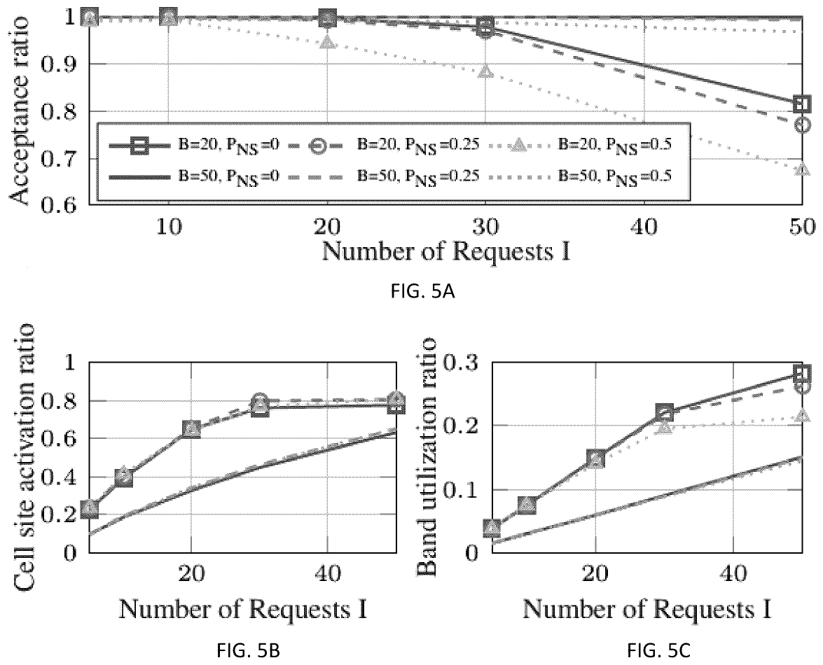

FIGS. 5A-5C depicts the acceptance, cell site activation, and band utilization ratios as a function of the number of requests for different values of P_{NS} and number B of cell sites controlled by NeutRAN. FIG. 5A shows that the acceptance ratio decreases when a larger number of requests is submitted to NeutRAN. Intuitively, the larger the number of requests, the higher the probability that not all requests can be accommodated due to the limited number of PRBs and spectrum bands. Moreover, when B=20, the acceptance ratio decreases from 82% for P_{NS}=( )(all cell sites support all W=5 bands) to 67% for P_{NS}=0.5 (the probability that a cell site does not support a band is 50%). The same applies when B=50, with the acceptance ratio dropping from 99.8% for P_{NS}=0 to 96% for P_{NS}=0.5. As expected, more cell sites also imply a higher acceptance rate as more resources are available to NeutRAN.

FIG. 5B shows that the cell site activation ratio always increases with the number of requests submitted to NeutRAN. The activation ratio is higher for B=20 than B=50, as NeutRAN's optimal policy requires the allocation of as many cell sites as possible in the available pool. Instead, FIG. 5C shows how different configurations affect spectrum utilization. Intuitively, the higher the number of submitted requests, the higher the number of spectrum bands to be allocated to support such requests and avoid interference among neighboring cell sites. Indeed, as the cell site activation ratio increases, more bands must be activated to eliminate interference while allocating the necessary PRBs. This happens in particular for the resource constrained case of B=20.

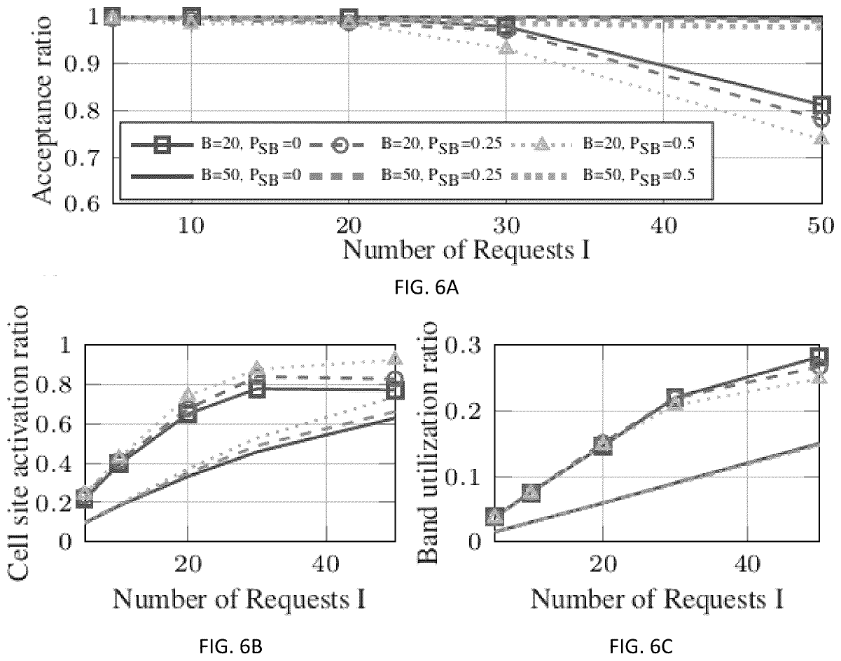

FIGS. 6A-6C report the same metrics for varying values of the probability P_{SB}. Trends for acceptance and band utilization rates are similar to those in FIGS. 5A-5C. However, varying P_{SB} affects the activation of cell sites to a higher extent as shown in FIG. 6B. Specifically, when half the cell sites can operate on a single spectrum band at any given time (P_{SB}=0.5), the activation ratio increases by approximately 20% compared to the case when all cell sites support multiple spectrum bands (P_{SB}=0). This illustrates the importance of deploying cell sites with RUs that can transmit simultaneously on multiple bands and that can accommodate more requests with a lower number of active cell sites (lowering operational and energy costs).

### B. Experimental Evaluation of RAN and Spectrum Sharing

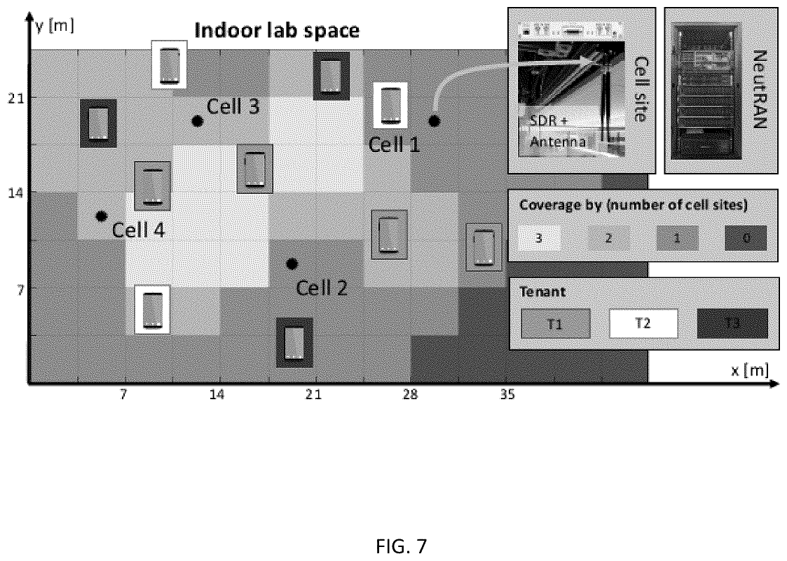

To evaluate the performance of NeutRAN in a real-world scenario, the prototype was deployed in an indoor space with multiple obstacles, heterogeneous equipment and moving humans, creating a wireless environment rich with scattering. The indoor area (FIG. 7) covers more than 1100 m2. It has been logically divided into A=91 tiles of size 3.5×3.5 m². The experimental configuration included B=4 cell sites, each with an USRP X310 frontend whose antennas are mounted on the ceiling of the testbed. Ten (10) commercial smartphones were deployed as shown in FIG. 7. Smartphones represent end users for a set [symbol] with T=3 different tenants (e.g., different mobile network or private network operators). Specifically, 4 users are served by tenant 1, and 3 each by tenants 2 and 3. Connectivity is provided over LTE Band 7 under an experimental license, and W=3 blocks with 10 MHz of spectrum (50 PRBs) each. Blocks are identified by a pair (f_{d}, fᵤ) of downlink and uplink carrier frequencies, with f_{d} ∈ {2.625, 2.645, 2.685} GHz and fᵤ ∈ {2.505, 2.525, 2.565} GHz. The coverage area of a cell site was conservatively defined as the set of tiles where users experience an average throughput higher than 50% of the throughput that the same user would experience in the tile with the cell site antenna. The result is the coverage map in FIG. 7.

To exhaustively evaluate the performance of NeutRAN, the three following scenarios were considered, each involving four independent experiments lasting more than 300 s each.

No sharing: this license-based scenario corresponds to a traditional cellular network deployment where each tenant (i) uses different cell sites without infrastructure sharing, and (ii) owns a dedicated, licensed portion of the spectrum. Each tenant operates independently on one of the three 10 MHz blocks. Since the RAN is not shared, tenant 1 serves users from cell sites 1 and 3, tenant 2 from cell site 2, and tenant 3 from cell site 4.

Sharing. 30 MHz: the NeutRAN optimization engine and automation pipelines are used to allocate tenant requests over different cell sites and spectrum. NeutRAN controls a total of 30 MHz, the same amount of spectrum available to the No sharing configuration. Each cell site, however, only provides service through a single pair of downlink/uplink carrier frequencies and a 10 MHz spectrum block.

Sharing. 10 MHz: this configuration is the same as Sharing, 30 MHZ, with the difference that the system is deployed on an overall spectrum of 10 MHZ, shared among tenants. Since only one band is available in this scenario (W=1), NeutRAN optimization engine does not enforce the interference constraint Eq. (3).

The KPMs were collected at the RAN side every 250 ms for each UE. Here, downlink throughput, downlink Modulation and Coding Scheme (MCS), and uplink SINR are considered. The UE downlink throughput was also aggregated over time to compute the average and median UE throughput and the total RAN throughput for each experiment. During the experiments, the smartphones stream videos through the YouTube application.

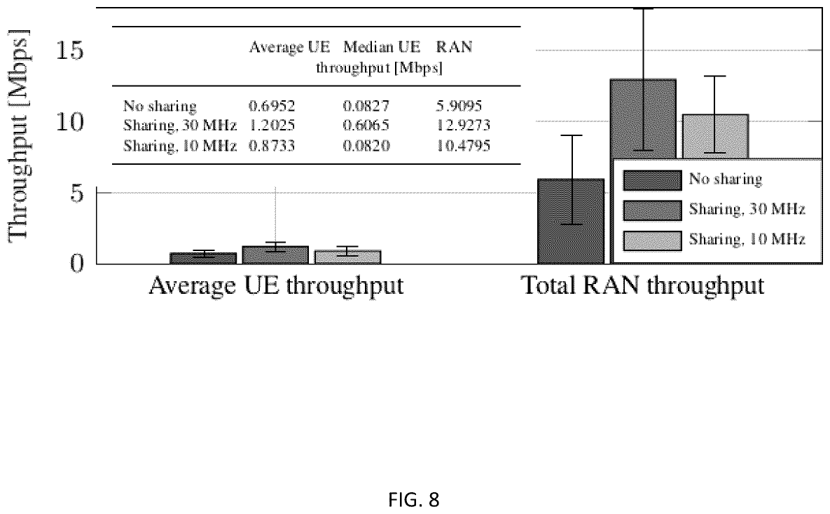

Experimental Results. It was investigated whether using the NeutRAN-enabled RAN and spectrum sharing improves network performance. FIG. 8 concerns the average throughput.

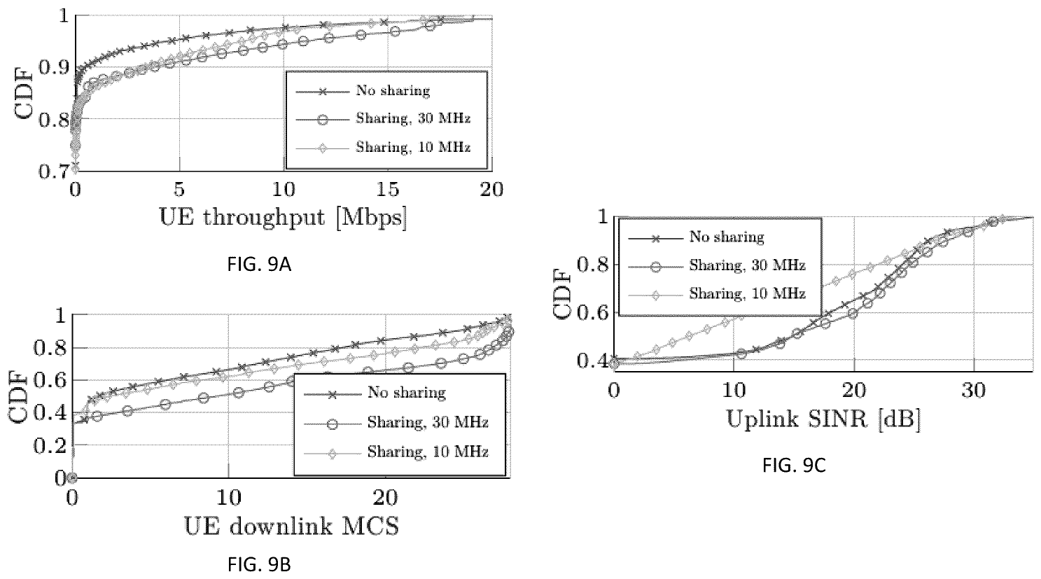

Both Sharing configurations outperformed the first one in the total RAN throughput, showing that a network with an optimized approach to resource management and sharing out-performs orthogonal license-based schemes. Sharing, 30 MHz achieves a 2.18× gain over No Sharing, and the setup with 10 MHz spectrum has a 1.77× gain, as also shown in the table part of FIG. 8. In addition, the Sharing approach with 30 MHz also outperforms the No Sharing scheme in terms of average and median throughput, suggesting that the improvement does not apply only to aggregated performance, but also, on average, to the single UEs. A similar behavior can be observed in FIGS. 9A-9B, which show the Cumulative Distribution Function (CDF) of the UE throughput and downlink MCS, respectively. Both Sharing scenarios outperform the No Sharing one.

Considering the Sharing setup with 10 MHz, it was observed that sharing the available spectrum improves the total throughput when compared to the case No sharing, with comparable average and median UE throughput. However, thanks to the capabilities enabled by NeutRAN, such comparable behavior is achieved by using ⅓ of the spectrum used in the No sharing setup. This is because RAN sharing allows tenants to optimally deploy their resources, e.g., by maximizing the coverage of their users and thus improving the downlink throughput and MCS (FIGS. 9A-9B), especially for users with the best channel conditions. However, when using a single 10 MHz block, interference is significant for cell edge users, as shown in FIG. 9C, which reports the uplink SINR experienced by each UE and shows an average 5 dB gap for 80% of the UEs between the 10 MHz Sharing setup and the others. This causes less fairness among the UEs in uplink.

Another aspect worth considering is related to how fast NeutRAN can deploy a fully working cellular network.

TABLE 1

| Application | Required Pods | Time [s] |
|---|---|---|
| Base Station | 1 | 9.55 |
| Core Network | 17 | 5.77 |
| Near-RT RIC | 13 | 2.93 |
| xApp | 1 | 2.35 |

Table 1 reports average deployment and instantiation time of differing applications on the OpenShift-managed NeutRAN infrastructure. That is, Table 1 shows the average instantiation time for the pods of specific micro-services (e.g., base station, core network, near-RT RIC, and xApp pods), as well as the number of pods required to run them. It was observed that NeutRAN can deploy an end-to-end cellular network on white-box infrastructure in less than 10 s, demonstrating its feasibility and effectiveness.

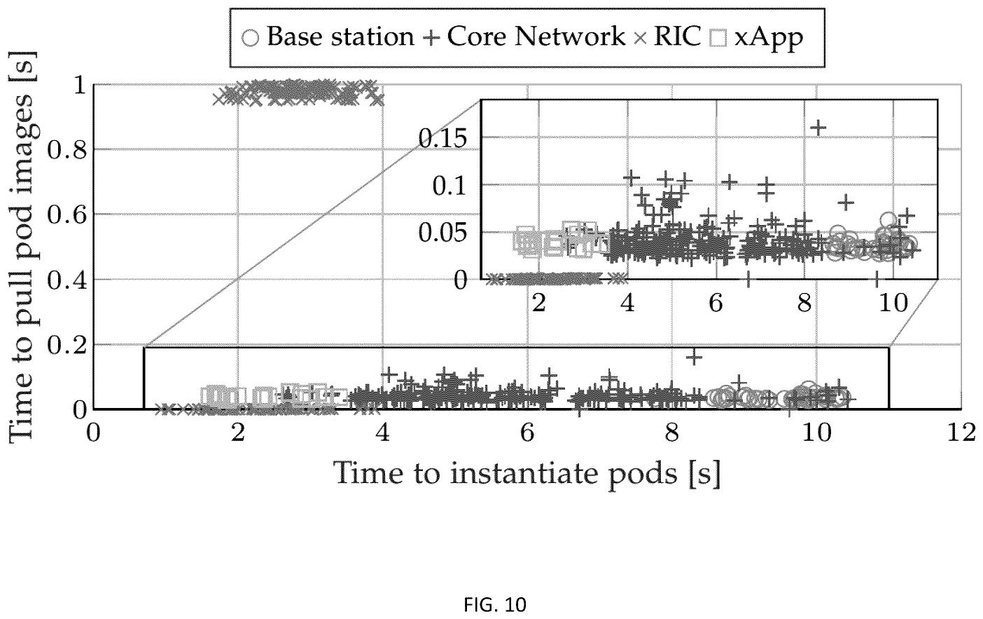

Similarly FIG. 10 shows the time taken by NeutRAN to instantiate each pod, as well as the time needed to download (pull) the pod image from the image registry to the physical machine where it will be instantiated. The xApps images are the ones that take the least time to be pulled and instantiated, with an average pull time below 0.1 s. A more diverse distribution can be seen in the pods of the core network, whose instantiation times range from 2 s to 11 s. The pods of the base stations have an average pull time of 0.1 s but they take the longest to be instantiated (as also shown in Table 1). Finally, since the pods of the near-RT RIC are the largest ones, and are hosted on the OSC Nexus image registry instead of locally on NeutRAN cluster, they require more time to be pulled (e.g., up to 1 s), but are instantiated within 4 s. These results show that, on average, NeutRAN can instantiate a fully functional cellular network in around 10 s.

### Integrated SAS Functionality Via Neutran

Deployment and operation of a cellular network is subject to many policies and regulations. For example, governmental and government-related organizations, such as, for example, the Department of Defense (DoD) and the Federal Communications Commission (FCC), impose requirements on, for example, spectrum allocation, signal prioritization, and interference prevention. For example, when the FCC allocated the Citizens Broadband Radio Service (CBRS) for private use, it was opening spectrum historically used exclusively by DoD stakeholders. In view of that shared use, CBRS was divided into three tiers. The highest-priority tier is referred to as “incumbents” and is reserved for military, governmental, and some satellite use. No transmissions are permitted to interfere with incumbents. The next tier is Priority Access License (PAL), for commercial businesses that acquire such PAL spectrum via auctions. All other users fall into General Authorized Access (GAA).

In order to ensure compliance with CBRS prioritization tiers, particularly with respect to avoiding interference with incumbents, cell networks and other mobile networks are generally required to use a Spectrum Access System (SAS) to manage spectrum assignment and power transmission levels.

Current SAS rely on sensor devices known as Environmental Sensing Capability (ESC) sensors to enforce FCC rules, manage spectrum allocation, and prevent radio interference, particularly with incumbent Navy transmissions. In general, the ESC, upon detection of an incumbent transmission within its zone, will reroute other transmissions within its zone to alternate spectrum bands to avoid interference Unfortunately, ESCs are standalone devices which must be separately installed to monitor transmissions in their respective zones and, because installing such ESCs represents a significant added cost to stakeholders, ESC are not universally deployed throughout all cellular networks. That is, there are many more RUs (e.g., cell towers/base stations) and DUs deployed than ESCs to monitor them. Furthermore, because the ESC's are separate and not integrated with other cellular network hardware such as RUs and DUs, ESCs cannot provide high granularity when rerouting communications and thus must preserve incumbent spectrum over a larger geographic zone than strictly required, negatively affecting available spectrum bandwidth and, therefore. PAL and GAA user experience.

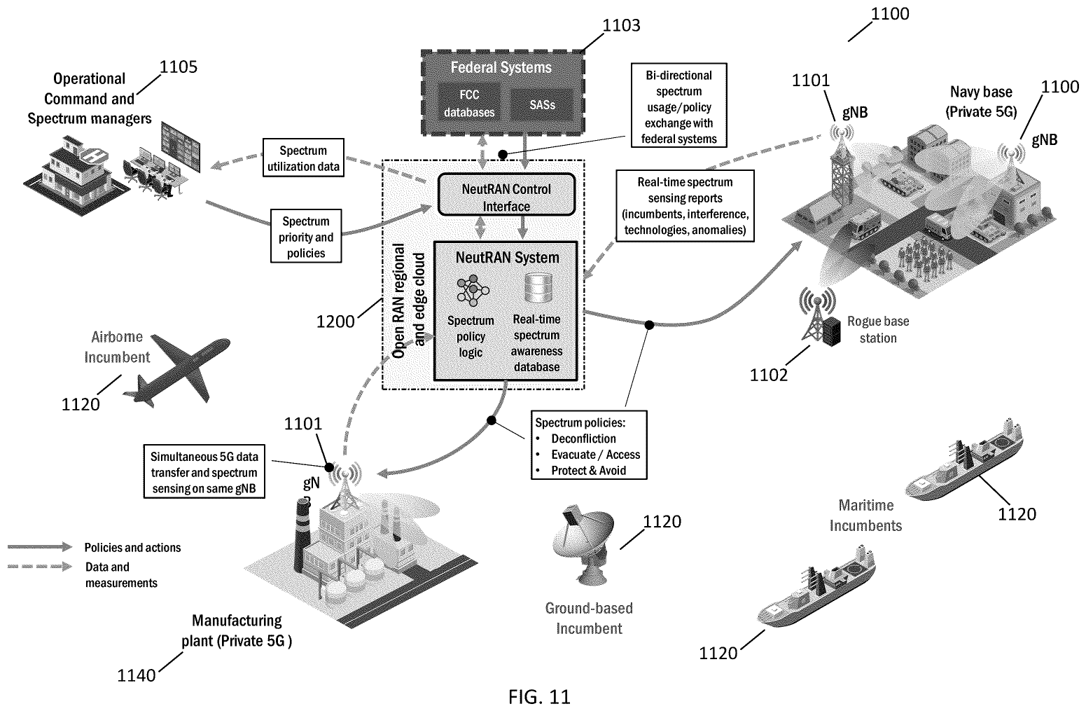

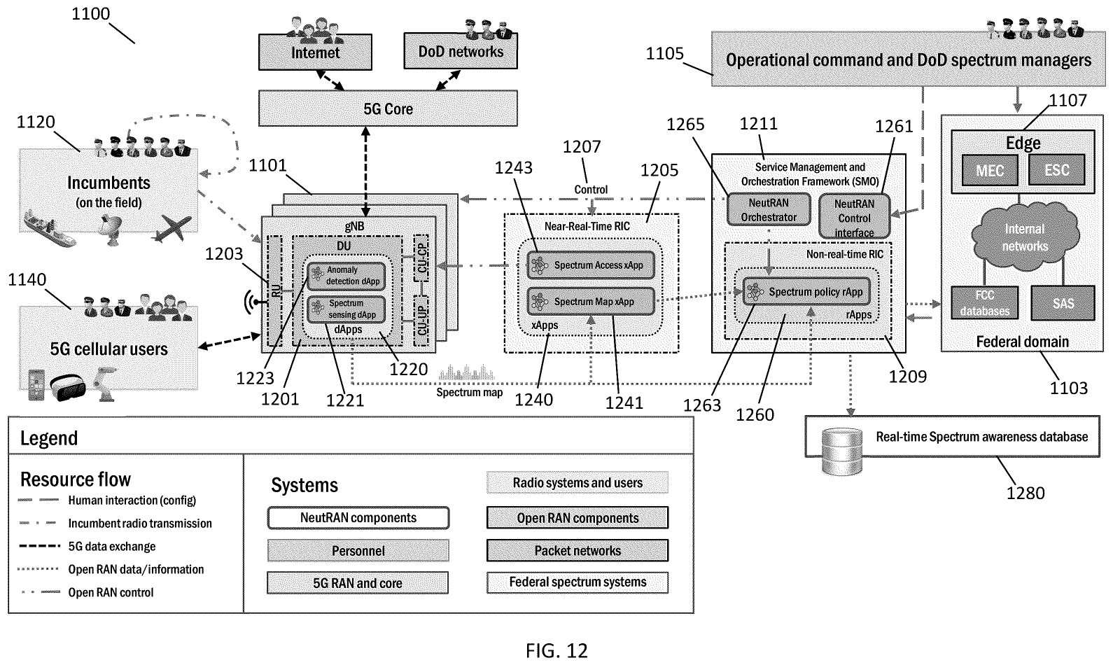

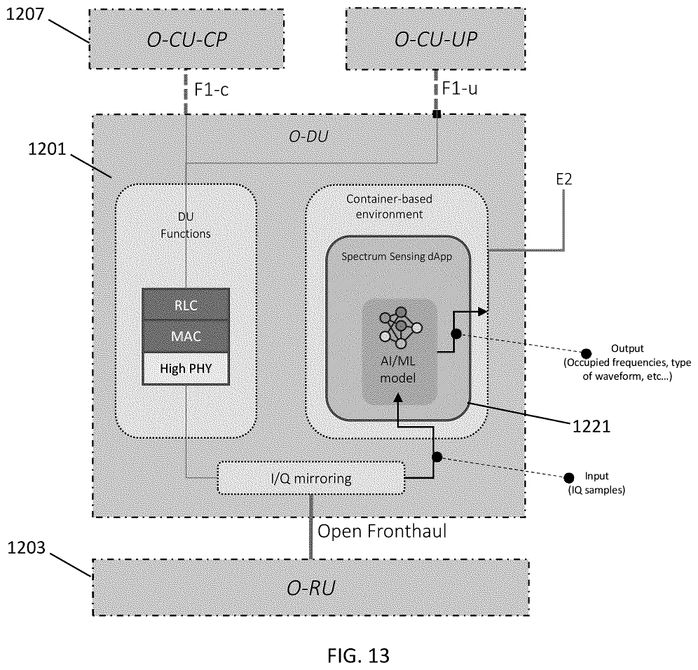

Referring now to FIGS. 11-13, a NeutRAN architecture 1200 can be configured and deployed within an open RAN cellular network 1100 to provide integrated ESC and SAS functionality. As shown in FIGS. 11 and 12, the network 1100 is deployed in an environment having a plurality of transmissions from both incumbent UE 1120 (e.g., airborne, ground-based, and maritime as shown) and private UE 1140 (e.g., 5G cellular users or the manufacturing plant). The cellular network 1100 includes a plurality of gNBs 1101 (or any other suitable base station or cell site) in communication with the NeutRAN architecture 1200 which, in turn, is in communication with various federal systems 1103 (e.g., FCC databases and SASs) and operational command and spectrum managers 1105 for receiving and providing spectrum sensing reports and utilization data as well as policy generation and deployment. In this manner, the NeutRAN architecture 1200 can provide holistic SAS functionality and control over the gNBs 1101 within the network 1100, as well as using integral function of the RUs and/or DUs of each gNB 1101 for ESC functionality.

As shown in FIG. 12, the NeutRAN architecture 1200 having integrated ESC and SAS functionality can be deployed on an open RAN to include one or more dApps 1220 deployed at each gNB 1101 (e.g., in a DU 1201 as shown or in a RU 1203), xApps 1240 deployed at a near-real-time RIC (near-RT RIC) 1205 (e.g., in a CU 1207), and rApps 1260 deployed at a non-real-time RIC (non-RT RIC) 1209 of the SMO 1211. In addition, the NeutRAN architecture can include a real-time spectrum awareness database 1280 in communication with the SMO for storing, updating, and retrieving historical and/or current spectrum state data for the cellular network 1100.

dApps 1220 deployed at each gNB 1101 can include a spectrum sensing dApp 1221 for monitoring spectrum activity within range of sensors (e.g., the RU 1203 or one or more antennae) of the gNB 1101. The dApps 1220 can also include an anomaly detection dApp 1223 for analyzing the transmission activity sensed by the spectrum sensing dApp 1221 and detecting any anomalies (e.g., detection of one or more incumbent signals or detection of transmissions in violation of one or more policies, such as incumbent-interfering transmissions from rogue base station 1102). Although depicted herein as separate dApps, in some embodiments, spectrum sensing and anomaly detection can each be provided in a single dApp. Furthermore, although shown as deployed in the DU 1201, dApps can be deployed in any gNB 1101 components or combinations thereof, including, for example, in the RU 1203.

xApps 1240 deployed in one or more near-RT RICs 1205 can include a spectrum map xApp 1241 for mapping a current state of hardware status and/or spectrum activity associated with the gNBs 1101 in communication with the near-RT RIC 1240 based on transmission or other spectrum activity data sensed by and received from the spectrum sensing dApps 1221 of those gNBs 1101. In addition, xApps can include a spectrum access xApp 1243 for deploying operational and policy constraints to each individual gNB 1101 in communication therewith based on policy constraints deployed to the near-RT RIC 1205 via rApps 1260 of the non-RT RIC 1209 and/or the SMO 1211 and the spectrum map xApp 1243.

rApps 1260 deployed in the non-RT RIC 1209 and/or the SMO 1211 can include a NeutRAN control interface 1261 for receiving commands and/or policy constraints from operational command and spectrum managers 1105. The rApps 1260 can also include a spectrum policy app 1263 for setting spectrum policies for the network 1100 based on 1) receiving the spectrum maps from the spectrum map xApps 1241 and/or the transmission or other spectrum activity data sensed by and received from the spectrum sensing dApps 1221, 2) data exchanged with federal systems 1103 and edge domain 1107 resources such as, for example, multi-access edge computing (MEC), conventional ESCs. FCC databases, and external SASs. 3) the commands and/or policy constraints received by the NeutRAN control interface 1261, and 4) feedback from the NeutRAN orchestrator 1265. The NeutRAN orchestrator 1265 can deploy the policies established by the spectrum policy rApp 1263 and/or the commands from the operational command and spectrum managers 1105 to the xApps 1240 of the near-RT RIC 1205 and/or the dApps of the gNPs 1101. In addition, the NeutRAN orchestrator 1265 can provide feedback regarding a state of the network 1100 and policy or command implementation throughout the network 1100 to the spectrum policy rApp 1263.

Some novel features of the present technology include:
Deployment of complex, customized core and RAN micro-services in a matter of seconds
Manages 5G disaggregated gNBs as well as the deployment of O-RAN RAN Intelligent Controllers (RICs) and their custom logic units, e.g., xApps and rApps, to satisfy tenant requests
Optimization engine that provides guarantees for (i) the execution of latency-critical computing tasks (e.g., a gNB) in shared infrastructures, and for (ii) the Quality of Service (QoS) and SLAs that tenants require for their users
Optimization engine is deployed as an rApp in the SMO, and leverages O-RAN interfaces to gather data and analytics on the RAN performance and to deploy the NeutRAN services.
   Some advantages of the present technology include:
Defined, developed, and prototyped over state-of-the-art tools for future cellular network innovation, which include OpenShift Kubernetes, O-RAN, and Software-Defined Radios (SDRs). As an open and virtualized framework, NeutRAN enables the deployment of complex, customized core and RAN microservices in a matter of seconds (e.g., 9.55 s for a gNB) from a centralized Service Management and Orchestration (SMO) entity to edge datacenters and cell sites that are part of the O-RAN O-Cloud. NeutRAN manages 5G disaggregated gNBs as well as the deployment of O-RAN RAN Intelligent Controllers (RICs) and their custom logic units, e.g., xApps and rApps, to satisfy tenant requests.
The NeutRAN optimization engine provides guarantees for (i) the execution of latency-critical computing tasks (e.g., a gNB) in shared infrastructures, and for (ii) the Quality of Service (QOS) and SLAs that tenants require for their users. The engine is based on the efficient solution of the neutral host problem, which considers tenant requests, available resources, and network analytics to generate an optimal allocation of micro-services and spectrum resources (e.g., spectrum slices). The problem is modeled as a binary Quadratically Constrained Quadratic Programming (QCQP) optimization problem that is solved optimally via reformulation-linearization techniques. The NeutRAN optimization engine is deployed as an rApp in the SMO, and leverages O-RAN interfaces to gather data and analytics on the RAN performance and to deploy the NeutRAN services.
Scalability, efficiency, and experimental evaluation. Experimentation shows that NeutRAN computes optimal solutions in less than 2 s for large-scale networks, allocating resources that meet the tenant requirements. Experiments were also run on a testbed having 4 softwarized cell sites and 10 commercial User Equipment (UEs) from 3 different tenants. NeutRAN was compared against a license-based, siloed RAN where operators control their own infrastructure and spectrum (10 MHz each: 30 MHz total). The results show that NeutRAN manages the total (now shared) bandwidth obtaining 2.18× RAN throughput and 1.73× average user throughput gains, with a consistent improvement in Signal to Interference plus Noise Ratio (SINR) over the license-based approach. It was also shown that, when NeutRAN is deployed on a total and shared bandwidth that is one third of the previous configurations (10 MHz), the optimized resource allocation at cell sites offsets the reduction in available spectrum, delivering an improvement in RAN throughput of 1.77× and unchanged average user throughput. This shows how the combination of virtualization, automation, and optimization to manage RAN and spectrum sharing brings remarkable network and user throughput gains.
Automated deployment of 5G/6G network functions, and coordination to share infrastructure and spectrum among tenants
Better QoE for users in terms of data rate, latency, and lower OPEX for operators
Higher performance support new 5G/6G services that can be monetized by operators and service providers
Human-centered data analytics and visualization facilitate network control and monitoring via policy suggestion and inefficiency/fault identification.
   Uses of the present technology include:
Public/private 5G/6G deployments
High-performance 5G/6G networks via data-driven control and adaptation
Smart warehouses (with robots, UAVs, humans, IoT)
Coexistence between 5G/6G and WiFi
CV2X for 5G/6G-based entertainment and self-driving cars
Private/public 5G for infrastructure and spectrum sharing among operators. Smart warehouses, arenas, theaters, stadiums, industrial plants
Radio Unit (RU) and Distributed Unit (DU) design.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

What is claimed is:

1. A system for sharing spectrum, computing resources, and Radio Access Network (RAN) elements in a wireless communication network, the system comprising:
a centralized service management and orchestration (SMO) entity, the SMO including an optimization engine for determining one or more resource allocation policies responsive to one or more received tenant requests and based on network state information received from a radio access network (RAN) and deploying the determined resource allocation policies on the network;
a plurality of edge datacenters configured to instantiate virtualized networking services in response to the deployed resource allocation policies from the optimization engine; and
a plurality of cell sites, the cell sites operating the network in response to instructions from the edge datacenters consistent with the deployed resource allocation policies.

2. The system of claim 1, wherein each received tenant request describes at least one of a service required, a resource needed, a fault-recovery policy, or combinations thereof.

3. The system of claim 1, wherein the network state information includes at least one of infrastructure availability, spectrum availability, or both.

4. The system of claim 1, wherein the resource allocation policies specify at least one of carrier frequency, bandwidth, cell site infrastructure, edge datacenter computing resources, or combinations thereof allocated to each tenant or tenant request.

5. The system of claim 1, wherein the optimization engine is executable as an rAPP deployed in a non-real-time (non-RT) RAN intelligent controller (RIC) hosted in the SMO.

6. The system of claim 1, wherein the edge datacenters instantiate the virtualized networking services in one or more near-real-time (near-RT) RAN intelligent controllers (RICs), non-RT RICs, 5G Next Generation Node Bases (gNBs), or combinations thereof.

7. The system of claim 6, wherein the near-RT RIC includes at least one xApp configured to instruct each of the cell sites to operate the network consistent with the deployed resource allocation policies.

8. The system of claim 6, wherein the near-RT RIC includes at least one xApp for monitoring the operation of the network.

9. A method of sharing spectrum, computing resources, and Radio Access Network (RAN) elements in a wireless communication network among a plurality of tenants, the method comprising:
receiving a plurality of tenant requests for network resources at a centralized service management and orchestration (SMO) entity;
determining, by an optimization engine of the SMO, one or more resource allocation policies responsive to the tenant requests, the policies based on the tenant requests and network state information received from a radio access network (RAN);
deploying the one or more resource allocation policies from the SMO to one or more edge datacenters
instantiating virtualized networking services in response to the deployed resource allocation policies from the optimization engine;
dispatching instructions from the edge datacenters to the cell sites in order to carry out the resource allocation policies; and
providing network services by the cell sites according to the resource allocation policies.

10. The method of claim 9, the step of determining the one or more resource allocation policies further comprising specifying at least one of carrier frequency, bandwidth, cell sites, edge datacenter computing resources, or combinations thereof allocated to each tenant or tenant request.

11. The method of claim 9, further comprising monitoring the provided network services by the edge datacenters and/or the SMO.

12. The method of claim 11, further comprising recovering the provided network services responsive to detection of a failure or potential failure in the provision of the network services.

13. The method of claim 9, further comprising executing the optimization engine as an rAPP deployed in a non-real-time (non-RT) RAN intelligent controller (RIC) hosted in the SMO.

14. A system for preventing interference in a wireless communication network comprising:
a plurality of cell sites of a radio access network (RAN), each including:
a spectrum sensing application for monitoring spectrum activity in the network; and
an anomaly detection application for detecting an operation of the cell site in violation of one or more policy constraints and for stopping or correcting operation of the cell site responsive to the detected violation:
a near-real-time (near-RT) RAN intelligent controller (RIC) including:
a spectrum map application for mapping a current state of spectrum activity associated with spectrum activity data received from the spectrum sensing applications of the cell sites; and
a spectrum access application for instructing the cell sites to operate the network consistent with the policy constraints; and
a centralized service management and orchestration (SMO) entity including:
a spectrum policy application for determining one or more of the policy constraints based on the mapping of the current state of the spectrum activity, the spectrum activity data, data external to the wireless communication network, or combinations thereof; and
an orchestrator application for deploying the policy constraints to the spectrum access application.

15. A method for preventing interference in a wireless communication network comprising:
monitoring spectrum activity by a spectrum sensing application of each of a plurality of cell sites of a radio access network (RAN);
mapping, by a spectrum map application of a near-real-time (near-RT) RAN intelligent controller (RIC), a current state of spectrum activity associated with spectrum activity data received from the spectrum sensing applications of the cell sites;
determining, by a spectrum policy application of a centralized service management and orchestration (SMO) entity of the RAN, one or more policy constraints based on the mapping of the current state of the spectrum activity, the spectrum activity data, data external to the wireless communication network, or combinations thereof;
deploying, by an orchestrator application of the SMO, the one or more policy constraints to a spectrum access application of the near-RT RIC;
instructing, by the spectrum access application, each cell site to operate the network consistent with the policy constraints;
detecting, by an anomaly detection application of the cell site, an operation of the cell site in violation of one or more policy constraints; and
stopping or correcting operation of the cell site responsive to the detected violation.

16. The method of claim 15, wherein each of the spectrum sensing applications is executable as a dAPP deployed in at least one of a distributed unit (DU) or a radio unit (RU) of the RAN.

17. The method of claim 15, the step of detecting further comprising detecting transmission of a non-incumbent signal on a same spectrum as an incumbent signal.

18. The method of claim 15, further comprising retrieving communications data from a data source external to the wireless communication network by the spectrum policy application, the data including at least one of FCC data, environmental sensing capability (ESC) data, spectrum access system (SAS) data, or multi-access edge computing (MEC) data.

19. The method of claim 18, wherein the step of determining further comprises at least partially basing the one or more policy constraints on the retrieved communications data.

20. The method of claim 15, further comprising:
receiving, at a control interface application of the SMO commands from one or more of an operational command manager or a spectrum manager;
wherein the step of determining further comprises at least partially basing the one or more policy constraints on the received commands.
